(19) United States
(12) Patent Application Publication
(10) Pub. No.: US 2012/0244503 A1
(43) Pub. Date: Sep. 27, 2012

(54) Method of Attention Recovery and Behavioral Modification

(76) Inventor: Carrie Neveldine, Fayetteville, NY (US)

(21) Appl. No.: 13/400,315

(22) Filed: Feb. 20, 2012

Related U.S. Application Data
(60) Provisional application No. 61/466,139, filed on Mar. 22, 2011.

(51) Int. Cl. G09B 19/00

(52) U.S. Cl. 434/236

(57) ABSTRACT

A method of attention recovery and behavioral modification is disclosed comprising a wearable device that alerts a user over provided intervals to facilitate re-engagement and regained focus on a particular activity. The method involves utilizing a vibratory or similar sensory stimulation means from a wristband that is adapted to train users to maintain focus or easily regain focus if their mind has begun to wander. The wristband is adapted to alert a user at defined intervals over a period of use or on demand remotely, which reminds the user that he or she should re-engage in an activity (meeting, classroom, etc.), wherein the method trains the user over time to regain focus on their own based on expected stimulus from the band that may be removed after extended exposure thereto. The method also contemplates tracking attention spans and success rates, along with reward systems for improving users.

### CROSS REFERENCE TO RELATED APPLICATION

This application claims the benefit of U.S. Provisional Application No. 61/466,139 filed on Mar. 22, 2011, entitled “Focus Band.”

### BACKGROUND OF THE INVENTION

1. Field of the Invention

The present invention relates to attention focusing methods and associated devices for those who may have attention disorders or difficulties remaining concentrated. A sensory stimulus reminds the user at a determined interval or via external input that he or she is supposed to re-engage in a present activity, discussion or event requiring attention or vigilance. More specifically, the present invention provides a method that alerts a user preferably utilizing a subtle vibratory wristband device such that the user regains conscious control over his or her attention wanderings, and can refocus efforts on a given task without losing time daydreaming or directing attention elsewhere. The method of use involves training individuals to expect a sensory input, training their minds to provide this input naturally and without external support. After a prolonged period wherein the frequency of sensory input is slowly reduced, the user is able to control his or her attention span independently. An associated method of tracking success and rewarding positive responses is also disclosed.

2. Description of the Prior Art

Many individuals suffer from short attention spans, have attention deficit conditions or have difficulty remaining focused on a given task over a given period of time. Some individuals have clinically diagnosed Attention Deficit Hyperactivity Disorder (ADHD) or ADHD predominantly inattentive (ADHD-PI), which are developmental disorders characterized by inattention and ease of distractibility. For these individuals, it is challenging to stay engaged in an activity, and often times impossible. Children and adults suffering from these conditions or disorders may have trouble staying attentive and productive at school or work, and find it easy to become distracted, day dream or otherwise stray from a given task requiring concentration and attention. Lack of attentiveness during school activities and lectures can lead to educational development issues and problems advancing through courses. Teachers may find working with these unfocused students challenging and time consuming, as the teacher must constantly ensure that the student is on task, focused, and engaged. In some instances, the lack of attention can be perceived as laziness or irresponsibility, which can lead to unfair judgments of the child. Further still, a child's peers may make fun of the unfocused student, which can be embarrassing and frustrating, and sometimes result in a lowered self-esteem. Those teachers inattentive to children with these specific needs may further be unsuited to help the child or properly relay educational information, to the detriment of the child and his or her education.

Attention problems in students is a particularly troubling issue in which the present method is particularly well suited. Young students suffering from attention deficit issues may find it difficult to stay focused for prolonged periods, impairing their ability to learn information during classroom lectures and therefore contributing to poor grade performance. Further still, these problems can manifest into physical symptoms that include fidgeting, impulse control issues and outbursts of hyperactivity, which can be harmful and distracting to a student's peers in an educational environment. The present method pertains to a non-invasive and non-medicinal treatment for these issues, wherein a subtle, physical stimulus is utilized to alert an individual that their attention is waning and that they must refocus their minds on a given task.

When in class, a teacher often refocuses students by physically reminders to regain their attention, including calling on the student, physically tapping or otherwise engaging the individual to draw their attention. This requires the teacher to take time away from other students or to disrupt a classroom lecture in order to address a particular student's attention issues, and detracts from the overall effectiveness of all of those involved. This type of attention recapturing and engagement may be ineffective and not adequate for addressing the particular student's needs. Therefore, the present method is presented to provide a more passive means of regaining a student's attention. A new method is desired that emulates a teacher's reminder without creating a burden on the teacher's time or disrupting other students, and one that can serve as a useful means for addressing easily distracted students. The present invention provides such a means, and one that does not require active teacher input in order to draw a student back into the present activity, wherein his or her is allowed to regain focused attention and continue the learning process.

Studies have shown that behavior can be adapted via an external stimulus that rewards or punishes a user based on a chosen activity that is desired or not wanted. Various means of stimulation are provided when a given negative or positive action is detected. After a period of time, this stimulation becomes expected if a user engages in that specific behavior which draws stimulation. The user then modifies his or her activity to prevent or engage this input, preventing it from occurring or specifically engaging the activity drawing a positive feedback. The stimulation can then be gradually removed over time. The learned behavior and expected outcome remains present in the target user even as the means of providing such stimulation is no longer present. The learned feedback is engrained in the user and is utilized to modify a specific behavior. Based on this principle, it is desired herein to disclose a method that utilizes this type of learned behavior and expected results by providing sensory input to a user having attention deficit problems, wherein the input is provided in chosen intervals. Over time, the intervals may be expanded to gradually remove the input and allow the user's natural expectations to control his or her behavior. The method preferably comprises utilizing a wristband device to provide a regimented series of inputs to alert a child or student user whose prolonged attention is difficult to retain. Over time and with positive reinforcement, the input can be removed while the behavior and positive effects of the device remain imbedded in the mind of the user, adapting the child's behavior to more healthy habits that allow prolonged periods of attention and focus.

Patents have been granted and applications published that relate to attention reminders and bracelets. These devices provide a means of input utilizing a wristband device, which is only one example of a means of sensory input for which the present invention may utilize. The present method is a series of steps that utilize any sensory input that is adapted to draw a student user's attention back into focus, whereafter this input can be slowly reduced and removed to allow improved self control over one's own ability to realize their mind has begun to wander. Related devices in the prior art involve the use of watches or bracelets to remind an individual of a calendar event or provide a notice to the user. Two such patent applications have published regarding devices that attempt to consistently provide a user with a reminder alert. One device is designed to remind a user when to take medications, the other reminds a user that they are engaging in an undesirable habitual behavior. These prior art devices are relevant to the present invention, but are also remarkably distinct in their purpose and function from the present method. They do not provide the steps necessary to facilitate the present method, but rather disclose electrical or mechanical devices that provide input to a user.

U.S. Patent Application No. 2006/0018200 to Pitocco is one such device that describes a combined wrist watch, pill box storage device and medical alert bracelet for a user to wear around the user's wrist. The device looks similar to a wrist watch and reminds a user when it is time to take his or her medication. The watch portion of the device is capable of having multiple alarms programmed into the watch. The face of the watch is hinged on one side and can be lifted open to reveal a small pill box. While the pill box is open, the underside of the watch face is exposed, and the user or emergency medical personnel can locate a small card that contains information regarding what medications the user is taking, and what pill are located in the pill box. The medications are written onto the card, rather than engraved, because medications often change over time. However, the user's medical alert information is engraved onto the bottom of the pill box. This potentially life-saving information typically does not change over time and is highly important for emergency responders to have access to. As such, engraving the pertinent medical information onto the device is very helpful.

Another interesting device is described in U.S. Patent Application No. 2007/0080812 to Perlman. This disclosure describes a device for discouraging certain undesirable behaviors of the user and includes a monitoring component which tracts user behavior. The device is designed for use by individuals who suffer from a variety of obsessive compulsive disorders where the affected individual habitually causes harm to him- or herself. The self-inflicted harm typically results from mindless, habitual behavior of the individual with the condition and these undesirable, harmful behaviors should be discouraged. Some of the conditions the device is recommended for include trichotillomania, a condition where the affected individual pulls out their own hair; onychophagia, which is the compulsive nail biting typically associated with feelings of stress or anxiety; compulsive skin scratching, which can cause open surface wounds and thumb sucking, which can damage the individual's teeth.

The Perlman device is designed to alert the user if they engage in the compulsive activity. The device is a series of proximity detectors for gauging where the user's hands are in relation to the particular area of the user's body that is affected by the compulsive condition. For example, if the user is a compulsive hair puller, and the user tends to pull hair from the scalp, the proximity device detector element would be located on the user's wrist and a sensor would be located on the user's head, perhaps attached to a hair tie. When the detector element has moved within a specified distance of the sensor, the device will alert the user that he or she is engaging the compulsive action that needs to be discouraged. The alert can be a noise emitted by the device, a flashing visual alarm, or a tactile indication to cease the habitual behavior, such as a mild electrical shock, could be administered to the user. The device is also capable of keeping track of the user's behavior.

The Perlman device is designed to only alert the user when the user begins to engage in the undesirable habitual behavior. The detector element must be in close proximity to a sensor to signal an alert to the user, wherein feedback between the two devices is required. The alert that results from the detector element and the sensor being in close proximity is designed to discourage the user's behavior. The present invention serves a similar but inverse function. The present invention is designed to subtlety but effectively remind a user that he or she should be engaging in a particular activity and that if his or her mind has wandered, that the user must refocus on the given task. The present method produces a sensory input at set intervals of time to recall the user's attention back to the activity, whereafter the prescribed method gradually phases this input out. An associated method of tracking success and rewarding positive behavior is also disclosed.

In light of the foregoing prior art devices, it is submitted that the present invention substantially diverges in design elements and steps from the prior art. Consequently it is clear that there is a need in the art for an improvement to existing attention focusing methods. In this regard, the instant invention substantially fulfills these needs. It should be noted that the method of the present invention affords substantial novelty over the apparatus utilized therefor, and it is desired to disclose a method of behavior modification that relates to individuals and students afflicted with attention deficit issues.

### SUMMARY OF THE INVENTION

In view of the foregoing disadvantages inherent in the known types of attention recovery and behavioral correction methods and devices now present in the prior art, the present invention provides a method wherein the same can be utilized to subtly alert a user that his or her mind has drifted from an activity requiring attention, that that he or she should attempt to regain focus via a physical stimulus and reward system.

It is therefore an object of the present invention to provide a new and improved attention focusing method that shares the advantages of the prior art and yet has none of the disadvantages.

It is another object of the present invention to provide the user with a method of treating attention deficit issues via a subtle physical stimulus that reminds a user that he or she should be engaging in a particular activity.

Another object of the present invention is to provide a method of treating attention deficit issues using a physical stimulus that initiates over predefined intervals or on-command by a proctor or teacher. The intervals may be more frequent at first and diminish over time, allowing the user to independently manage and gain control over his or her ability to refocus on a task or activity.

Yet another object of the present invention is utilize a method that discreetly alerts a user to regain focus to prevent potential embarrassment of the user.

A final object of the present invention is to provide a method of treating attention deficit issues that includes a tracking and reward system for users engaged in the method, wherein success can be tracked and attainable goals may be sought after and upon successful completion of tasks requiring ever-increasing lengths of attention and concentration.

Other objects, features and advantages of the present invention will become apparent from the following detailed description taken in conjunction with the accompanying drawings.

### BRIEF DESCRIPTIONS OF THE DRAWINGS

Although the characteristic features of this invention will be particularly pointed out in the claims, the invention itself and manner in which it may be carried out and used may be better understood after a review of the following description, taken in connection with the accompanying drawings wherein like numeral annotations are provided throughout.

FIG. 1 shows a flow diagram outlining the key steps of the present method.

FIG. 2 is a perspective view of an example sensory input device utilized by the current method as a means to alert the user that he or she has drifted from a task.

FIG. 3 is a perspective view of the present method in a working position, wherein a sensory device is alerting a user that he must re-engage or refocus on a particular activity.

### DETAILED DESCRIPTION OF THE INVENTION

Reference is made herein to the attached drawings. Like reference numerals are used throughout the drawings to depict like or similar elements of the attention recovery method. For the purposes of presenting a brief and clear description of the present invention, the preferred embodiment will be discussed as used for regaining a user's attention using a subtle sensory stimulus. The figures are intended for representative purposes only and should not be considered to be limiting in any respect.

The present method provides a means to correct behavior issues in young children and adults with regard to attention and focus. Maintaining focus over a prolonged period can be difficult for some individuals, and particularly for younger students in a classroom setting. These individuals lack the ability to control their impulses or their mind from roaming from a given task, and further waste valuable time without being focused on a given task or activity. This reduces one's ability to absorb and retain information during lectures, and further reduces one's effectiveness during tests or other individualized or hands-on activities requiring detailed attentiveness. The overall goal of the method is to disclose a process that provides a user the ability to realize he or she has become distracted and to instill the ability to control impulses and refocus efforts on a given task independently of negative input, such as teacher reprimands or poor grades as a result of such activity.

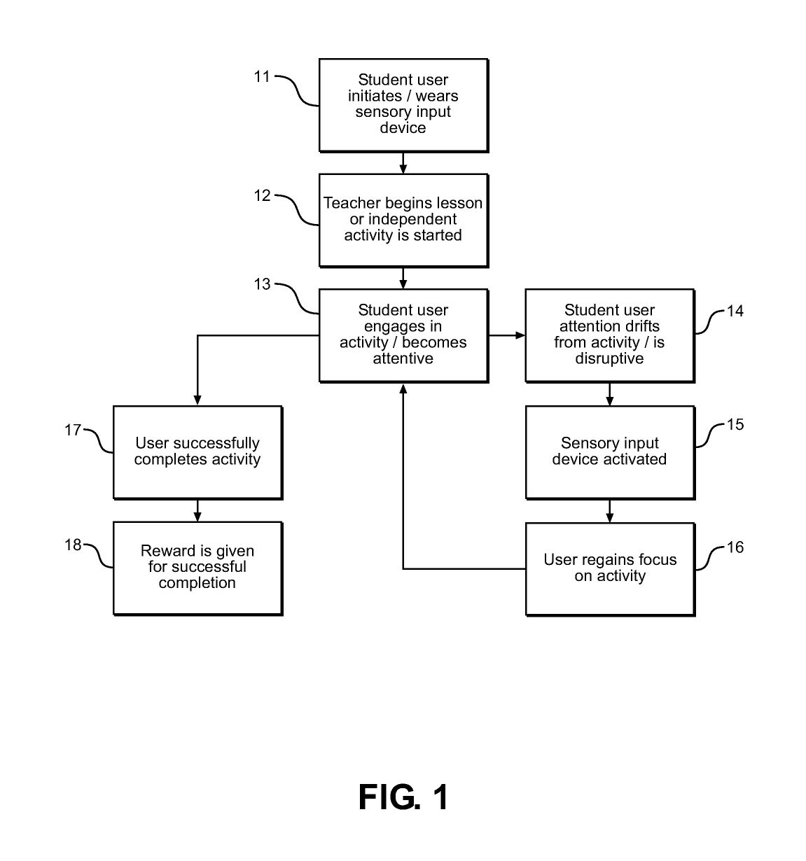

Referring now to FIG. 1, there is shown a flow diagram outlining the steps in the present method. The first step 11 includes deploying a sensory input device that is attachable or otherwise able to communicate a sensation or stimulus to a given individual. This device is preferably one that causes minimal distractions to those students or individuals nearby the user, wherein the input is not noticeable to anyone other than the user wearing or utilizing the device. Audible inputs and devices that are placed in a user's workspace are contemplated, but less desired in situations wherein many users are collectively engaged in an activity or listening to a lecture. More suitable are physically worn devices, such as wristbands and watches that provide physical stimulus in the way of a vibratory input and a visual message alerting the user that he or she must refocus attention. Once this input device is activated or worn by the user, a teacher may begin 12 a lesson plan, assign an activity or the user may initiate an examination. Any activity in which a user is required to employ concentration, wherein misuse of time or non-attentiveness would be to the detriment of the user or those around the user is a contemplated use when deploying the present method.

The next step in the method involves the student or user engaging 13 in the given task. During this stage, the student may become distracted or focus may wane 14 in a short period of time, which would otherwise prevent the student from gaining valuable lecture information, cause a reduction in effectiveness during an activity or waste time during an examination. The sensory input device of the present method is adapted to initiate 15 during this stage, providing a stimulus or input for the user to realize he or she has drifted, and allows the user to regain control and refocus on the particular activity 16. The ability to alert a user is the first step to regaining control, as often times a user is not aware that they have drifted and therefore requires notice that they must re-engage an activity. The sensory input device of the present method provides such a means, and one that preferably is subtle, non-harmful to the user and is not distracting for nearby individuals or students. The device further prevents a teacher from stopping a lecture to address a single student who is misbehaving, not paying attention or is being disruptive. The ability to self regulate behavior prevents these distractions and stoppages, which otherwise affect all users involved in the activity, examination or lecture.

Once the device has initiated, the alert is provided, and the user is able to regain focus, the ability to stay on task and successfully complete a task 17 are facilitated. Once a task is successfully taken to completion, the user is provided a reward 18 that incentivizes the user's willingness to stay on task and complete an activity. The success is tracked to mark the statistics associated with the user's success and to plot improvement in overall attentiveness and ability to stay concentrated. In this way, the user is both rewarded for their improving behavior, while at the same time able to realize how they have improved through the present method using defined statistics based on empirical data rather than a “feeling” of improvement. This further encourages and cements the steps of the method in the mind of the user, wherein progress is easily seen as attentiveness improves, improving the quality of learning for the user and those otherwise affected by the user's focus issues or disruptiveness.

The activation of the sensory input device occurs over defined intervals and is adapted to provide a diminishing stimulation for the user, conditioning the user to expect the stimulation and act in accordance with that expectation of being alerted to regain focus. As the stimulation is slowly removed, the user finds that he or she is self-regulating impulse and focus control in the absence of the stimulation. The stimulation is therefore less of a crutch, but rather a training device that provides an alert such that a user may take ownership of his or her mind wanderings and explicitly monitor how engaged he or she is during a given activity. It is desired to disclose several mechanisms for accomplishing this task, including the use of timed input intervals that diminish over a predefined timeline, wherein input from a proctor, teacher or coach may also tweak the intervals as necessary for a particular user. Alternatively or concurrently, manual activation of the stimulus may be initiated by the same proctor or teacher if manual control is desired, wherein specific instances of such control may be necessary when student outbursts or disruptions must be quickly addressed to prevent distractions for neighboring individuals and when time is a factor (examinations, short lectures, etc.). As the stimulation teaches the user that he or she can control their ability to concentrate without outside influences, their confidence improves, along with their attentiveness and ability to learn/succeed in an educational environment. The gradual removal of the sensory input is meant to be subtle, wherein the same interval may be kept for a period of time until dropping slightly in frequency, whereafter the input becomes less and less frequent. Eventually, it is desired that the user can self-regulate his or her focus without the use of the device, as the user is taught to continually monitor his or her concentration level. The flow diagram of FIG. 1 shows a continual loop on the side wherein focus is waning and the alert is necessary. The sensory input is utilized until the student is finally able to successfully complete a task.

Upon successful completion of a task, the present method contemplates both a reward structure 18 and a means for recording success, which takes into account the frequency of the sensory input, the disruption level and the grades of the student. In this way, the user is provided an incentive for successfully completing a task and staying in focus, while his or her success is tracked over the long term to determine the effectiveness of the method and its specific implementation. The reward structure may take several forms and will depend on the demographics of the given user or population of users within a setting. For younger students in grade school, a bar chart of smiley faces or stars may be used, wherein continual success leads to more faces or stars until a goal is reached. Once the goal is reached, a prize may be issued in the form of snacks, increased play time or an activity in which is enjoyable for the user or the entire classroom. For older students, grade incentives and free time may be granted, game time may be given during school hours, or finally homework exemptions may be provided. Any such reward system that provides an incentive for success is contemplated, and may take several forms depending on the age and background of the user population. In a similar fashion as the diminishing sensory alerts, the reward system is desired to be tiered, wherein initial prizes may be more trivial and easier to obtain, whereafter further rewards may be more substantial and harder to qualify for. This provides increasing incentives for the student user as more attention is required over time and with less outside influence. The ability to concentrate independently is put to the test and the reward increases.

Charting success for the present method and for particular users is paramount for educators, parents and those associated with deploying the present method for tracking the program's overall success and the success of a particular student. Educators and parents can see improvements in the behavior and success rate of a child, reinforcing the implementation of the device and building confidence in its use. If no progress is being realized in the statistics of a user, the intervals of sensory input may be altered, the rewards may be changed to be more suited, or another variable may be tweaked facilitate increased focus improvement and educational success. The success of the student user may come in the form of variables being tracked, such as notes taken for each student upon instances of outbursts or auditing the student during class. Student notes taken during lectures may be collected and graded, showing how each student is actively engaging in the duration of each lecture. Further, test scores and overall grades may be analyzed for trends to show improvement or decline in a student's performance while utilizing the present method of focus treatment.

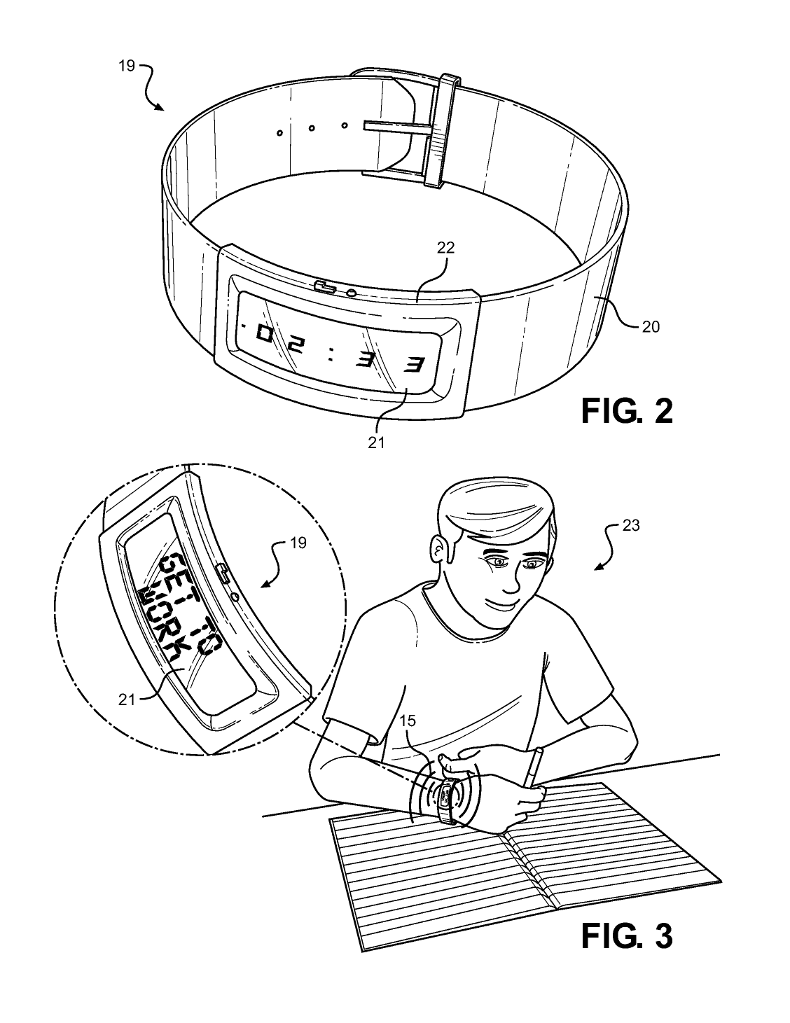

Referring now to FIG. 2, there is shown a perspective view of an exemplary embodiment of the sensory input device utilized by the present invention. Specifically a vibratory and visual wristband device 19 is utilized as a means to stimulate both the touch and sight senses of the user to alert him to regain focus. At the same time, the wristband may provide a means to tell time, similar to a standard wristwatch. The wristband employs an adjustable band 20 that may be made of soft silicone or other flexible, slightly elastic material that is comfortable to be worn and not distracting for the user. The device has a digital display screen 21 located at the center of the wrist band 20. Beneath the display screen and within the screen housing 22 is an electromechanical vibrating mechanism which can be programmed to vibrate periodically and/or upon request of a user proctor or teacher. The user can set the device to vibrate as frequently as necessary and according to an algorithm that may vary the frequency in a nonlinear, decaying trend. The device may be plugged into a computer for control or may be independently controlled on the wristband itself, wherein a preset algorithm controls its use. It may be desired that no physical controls are provided on the device, which prevents tampering by younger or more petulant students. It is further contemplated that a master controller utilized by the teacher may be used to initiate the vibration means on-demand and remotely, as desired by the teacher during lesson, activity or exam.

Referring now to FIG. 3, there is shown a view of the present method and device therefor in a working position, wherein a student user is wearing a wristband sensory input device 19 that alerts him to stay focused during an examination or while note taking. The wristband preferably provides a vibratory input along with a message on a digital display 21, which can depict small images, characters, designs or the time of day. When the vibration mechanism activates 15, it subtly reminds the student user 23 that he is supposed to be engaged in a class room assignment, and that he should refocus his mind on the given assignment or lecture. The device 19 is designed to facilitate the present method by helping the user 23 independently regain focus by means of a discreet alert system notifies the user to get back to work and pay attention. The vibration and visual means of notification is designed not to incur notice by those individuals situated nearby the user, adding discretion to the overall method if the entire classroom is not utilizing the present method, but rather it is deployed on selected students with attention deficient issues.

The use of both a visual and physical cue is useful for associating the alert with the “get to work” mentality or mantra, wherein the use of the present method and sensory input eventually equates the user with a directed task. The sensory input can be slowly dialed down or removed, while the learned behavior of focus control and monitoring daydreaming is retained. Associated with this learned behavior must be a motivational incentive with each success, wherein initial achievements are easily attained and thereafter become gradually more difficult and take a longer to obtain. The child user needs to know what behaviors he or she needs to display in order to earn the incentive, while the sensory alert provides a physical mechanism to continually remind and reinforce this focus on attentive behavior.

Traditional and existing means of overcoming focus and attention disorders are cumbersome to teachers and overseers, or require pharmacology. While the present method may not fully substitute these options in some cases, it is desired to disclose a method of focus control that utilizes physical stimulus, rewards for success and a means to track performance over time. The disclosed wristband is a particularly useful embodiment that allows individuals with attention deficit disorders or for those who are easily distracted or sidetracked to subtly be reminded to regain focus. The vibrating mechanism quietly and discreetly affects a user without embarrassment or alerting others, while the programmed intervals of stimulus can be controlled and diminished over time to remove this crutch, and leave behind a regimented pattern of behavior that allows self-monitoring of focus behavior.

In light of the prior art and the present disclosure, it is herein submitted that the instant method has been shown and described in what is considered to be the most practical and preferred embodiments. It is recognized, however, that departures may be made within the scope of the invention and that obvious modifications will occur to a person skilled in the art. With respect to the above description then, it is to be realized that the optimum steps of the invention, to include variations in implementation, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1) A method of attention recovery and behavioral modification, comprising the steps of:
providing a sensory input device for a user, which provides at least one sensory alert;
initiating an activity of which requires user attention or focus;
activating said sensory alert at a defined time interval after activity initiation to allow user to regain or realize focus is necessary;
activating said sensory alert in a defined frequency during said activity;
providing a reward for said user upon successful completion of said activity;
tracking said performance statistics to show improvement in focus of said user.

2) The method of claim 1, further comprising the steps of:
decreasing said sensory alert frequency over a time period to reduce dependency thereof and allow a user to independently monitor his or her focus levels.

3) The method of claim 1, further comprising the steps of:
increasing the difficulty in which rewards are distributed over a time period to increase said user's willingness to increase focus levels and performance.

4) The method of claim 1, further comprising the steps of:
providing a means to actively initiate said sensory alert on-demand for a teacher or overseer to initiate between said alert intervals.

5) The method of claim 1, wherein said sensory alert comprises a vibratory wristband that activates a touch stimulus for said user.

6) The method of claim 1, wherein said sensory alert comprises a vibratory wristband with a display screen having a message that activates both touch and visual stimuli for said user.

7) The method of claim 1, wherein said sensory alert frequency decays according to a defined algorithm over time and is modifiable by a teacher or overseer.

8) The method of claim 1, wherein said performance statistics utilize variables that comprise frequency of the sensory input, disruption level of said student and said student grades during said activities.
